(19) United States
(12) Patent Application Publication
(10) Pub. No.: US 2011/0047051 A1
(43) Pub. Date: Feb. 24, 2011

(54) DONATION METHOD

(75) Inventors: Mark Stephen WILSON, Queensland (AU); William Michael Paige, Pullenvale (AU)

Correspondence Address: NIXON & VANDERHYE, PC, 901 NORTH GLEBE ROAD, 11TH FLOOR, ARLINGTON, VA, 22203, US

(73) Assignee: AIDARENA PTY LTD., Queensland (AU)

(21) Appl. No.: 12/868,151

(22) Filed: Aug. 25, 2010

Related U.S. Application Data
(63) Continuation-in-part of application No. PCT/AU2010/000143, filed on Feb. 10, 2010.

(30) Foreign Application Priority Data
Feb. 26, 2009 (AU) 2009900852
Sep. 24, 2009 (AU) 2009904647

(51) Int. Cl. G06Q 30/00

(52) U.S. Cl. 705/27.1

(57) ABSTRACT

A method of donating to a beneficiary is disclosed. The method includes presenting online, using computational means of an administrator, a product donated by a donor. The product is associated with at least one beneficiary. The administrator receives payment for the product from the buyer, a beneficiary or an intermediary for the sale of the product. The administrator, when payment is received from the buyer or the intermediary, sends a donation deducted from the payment to the beneficiary.

This application is a continuation in part of International Patent Application No. PCT/AU2010/000143 and claims priority from Australian Provisional Patent Application Nos. 2009900852 and 2009904647, filed 26 Feb. 2009 and 24 Sept. 2009, respectively.

### TECHNICAL FIELD The present invention relates to a donation method.

### BACKGROUND

The reference to any prior art in this specification is not, and should not be taken as an acknowledgement or any form of suggestion that the prior art forms part of the common general knowledge.

Fundraising is a problematic task for charities and institutions from schools, churches and community groups to international institutions like Red Cross. In recent years a phenomenon known as donation fatigue has arisen so that people are less and less likely to respond to direct outreach methods that seek monetary donations. Furthermore, telemarketing, direct mailing and door knocking are expensive and time consuming exercises that may be too administratively intensive for small organisations, for example primary schools, to wish to become involved in. At the same time traditional fundraising exercises, such as selling confectionary or holding school fetes can only be undertaken once or twice a year.

In the last fifteen years the Internet has become prevalent and has penetrated most homes and businesses in Australia. The Internet has been used for charity fundraising, for example “pop-up” advertisements are sometimes used to request donations and direct browsers to webpages that facilitate financial donations, for example by way of credit card payment. However, the majority of Internet users tend to ignore these advertisements.

It would be desirable if a donation method was provided that addressed one or more of the above-described problems.

### SUMMARY OF THE INVENTION

According to one aspect of the present invention, there is provided a method for donating to a beneficiary, the method including the steps of:
presenting online, using computational means of an administrator, a product donated by a donor and for sale to a buyer, the product being associated with the beneficiary;
enabling the administrator to receive payment from the buyer, beneficiary or an intermediary for the sale of said product; and
enabling the administrator, when the payment is received directly from the buyer or the intermediary, to send a donation deducted from the payment to the beneficiary.

It will be understood that the term “administrator” used herein does not include within its scope a charity.

It will be understood that the terms “product” used herein may be at least one good and/or service.

Preferably, the step of enabling the administrator to receive payment involves enabling the computational means to receive payment such as an electronic payment from the buyer, beneficiary or financial institution system for the sale of said product.

Preferably, the step of enabling the administrator to send payment involves enabling the computational means to send an electronic donation deducted from the payment to the beneficiary.

Alternatively, the payment and donation may be in the form of cheque (check) or cash.

The sending of the donation may be automatically performed subsequent to the receiving of the payment.

Prior to the step of presenting, the method may include the step of filtering by beneficiary, products donated by donors and for safe to buyers.

Prior to the step of presenting, the method may further include the step of enabling a donor of the product to associate the product with one or more beneficiary. The donor may also associate the product with one or more beneficiary and the method may further include the step of sending another electronic donation or other electronic donations deducted from the payment to the or each beneficiary. The or each beneficiary may be selected from a group of potential beneficiaries.

Prior to the step of enabling the donor to associate the product with the beneficiary, the method may further involve the step of enabling the donor to register the product for donation.

The donation may amount to the payment. Typically the donation is less than the payment amount and thus the difference between the payment and the donation may be the administrator fee. The administration fee may be the amount that is left after the donation and freight charges (if any) have been deducted from the payment made by the buyer.

The payment may include a freight payment and the method may further include the step of sending the freight payment deducted from said payment to the donor. Alternatively, the administrator may enable a separate freight payment to be paid by the buyer and directly to the donor.

The payment may include an administrative commission. The payment may take the form of electronic funds transfer (EFT) or may be a credit card or debit card payment or may be a cheque (check) payment.

Subsequent to the step of presenting, the method may further include the step of auctioning the product.

The method may further include the steps of generating a tax receipt for the donation, and sending the tax receipt to the donor. It is envisaged that the tax receipt may be generated and sent to the donor by the charity. However, in a preferred embodiment of the invention, the tax receipt is generated by the administrator on behalf of the charity. In this embodiment of the invention, the administrator may also send the tax receipt to the donor. In this way, the administrative work required of the charity is minimised. This may also result in the charity being able to maximize the amount of funds received used for charitable purposes rather than to cover the charity's administrative costs.

It is envisaged that the form and contents of the tax receipt will vary depending on the tax requirements of the jurisdiction (country, state, province etc) in which the tax receipt is generated.

It is envisaged that, in order to allow the administrator to generate and send tax receipts, the or each charity will authorize the administrator to issue tax receipts on its behalf. Any suitable authorisation may be used, and it is envisaged that the form and content of the authorisation will vary depending on the requirements of the jurisdiction (country, state, province etc) in which the charity and/or the administrator is located. For instance, in some jurisdictions, a verbal authorisation may be sufficient, while in others, a written agreement between the charity and the administrator may be required. Alternatively, the administrator may provide online means whereby the charity may authorize the admininstrator to generate and send tax receipts on its behalf. Such online means may include, for instance, a check box on a webpage or the like.

According to another aspect of the present invention, there is provided the tax receipt generated in accordance with the method.

According to one aspect of the present invention, there is provided a method for donating to one or more beneficiaries, the method including the steps of:
presenting, with computational means of an administrator, a product donated by a donor and for sale to a buyer, the product being associated with the or each beneficiary;
receiving, with the computational means and from a financial institution system, confirmation of payment for the sale of said product by the buyer; and
sending, with the computational means and to the financial institution system, a request for a donation taken from the payment to be paid to the beneficiary.

According to a further aspect of the present invention, there is provided a media, such as a magnetic or optical disk or solid state memory, containing computer readable instructions for execution by computational means to thereby perform any one of the preceding methods.

According to a further aspect of the present invention, there is provided computational means configured to perform any one of the preceding methods.

According to another aspect of the present invention, there is provided a computational means of an administrator configured to donate to one or more beneficiaries, the computational means configured to:
present a product donated by a donor and for sale to a buyer, the product being associated with the beneficiary;
receive, from a financial institution system, confirmation of payment for the sale of said product to the buyer; and
send, to the financial institution system, a request for a donation associated with the payment to be paid to the beneficiary.

According to yet a further aspect of the present invention, there is provided a method for donating to a beneficiary, the method including the steps of:
presenting online, using computational means of an administrator, a product donated by a donor and for sale to a buyer, the product being associated with the beneficiary;
enabling the administrator to receive payment from the buyer, beneficiary or an intermediary for the sale of said product;
enabling the administrator, when the payment is received directly from the buyer or the intermediary, to send a donation deducted from the payment to the beneficiary; and
enabling the administrator, on behalf of the beneficiary, to generate a tax receipt and send the tax receipt to the donor, wherein the product is at least one good and/or service.

Preferably the product is auctioned. The product may be both a good and a service.

It is envisaged that a charity may provide a link to the administrator's online interface from its own online interface, such as a website if applicable. In a preferred embodiment, the link may direct a user to a list of the goods and/or services that have been donated and to which the particular charity is listed as the beneficiary. Thus, a user may quickly determine what goods and/or services may be purchased for which the proceeds will flow to a selected charity.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic diagram of a donation system for performing a donation method in accordance with an embodiment of the present invention;

FIG. 2 is a diagram showing the allocation of funds between parties when performing the donation method in accordance with an embodiment of the present invention;

FIG. 3 is a flowchart showing the donation method in accordance with an embodiment of the present invention; and

FIG. 4 is a schematic diagram showing a server of an administrator of the donation system of FIG. 1.

### DETAILED DESCRIPTION OF PREFERRED EMBODIMENTS

Throughout this specification, the term “product” means one or more “goods and/or services”.

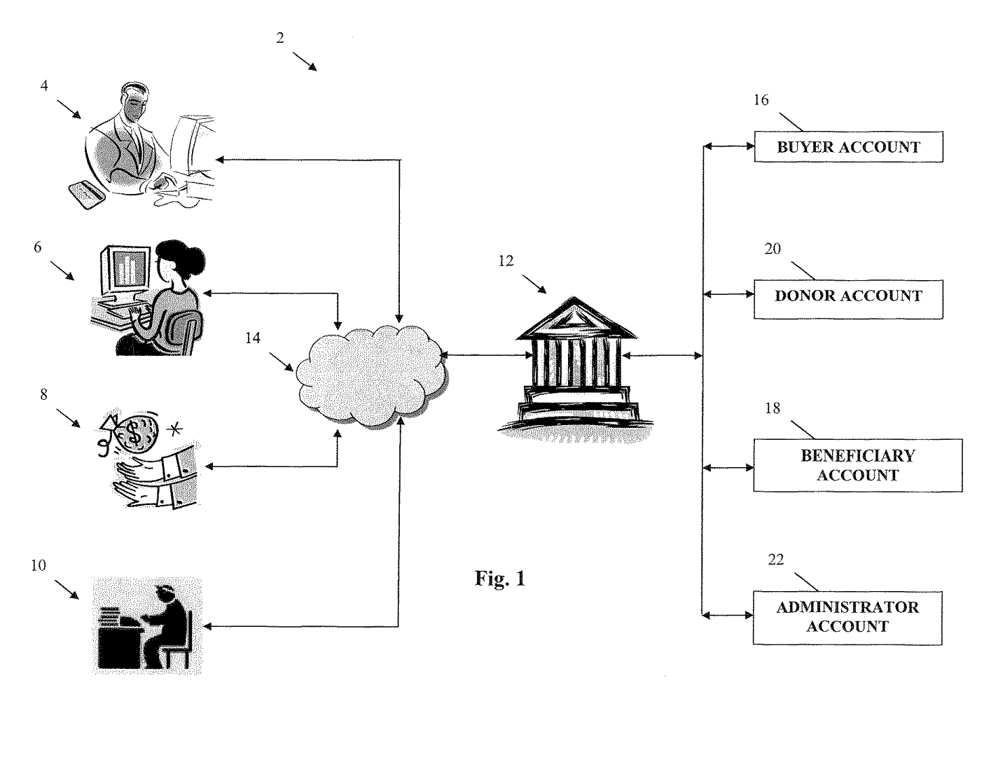

Referring to FIG. 1, there is provided a donation system (designated by reference numeral 2) for performing a donation method when a buyer 4 purchases a donated product from a donor 6. The donation method involves receiving an electronic payment from the buyer 4 for the sale of the donated product, and then sending an electronic donation deducted from the payment to a beneficiary 8 (e.g. charity, school, etc.).

The donation system 2 includes the beneficiary 8, a donation system administrator 10 and a financial institution system 12 (e.g. Westpac Bank, Commonwealth Bank, etc.), each including a computer server and interfaced together via at least one computer network 14. The financial institution system 12 may include one or more banks or other like financial institutions. The buyer 4 has a buyer card (i.e. credit card or debit card) issued by the financial institution system 12 and linked to a buyer account 16. The beneficiary 8, the donor 6 and the administrator 10 have respective accounts 18, 20, 22 with the financial institution system 12 accessible by the institution system either directly or indirectly. Both the buyer 4 and donor 6 have personal computers (PCs) interfaced to the network 14 which, in turn, includes the Internet.

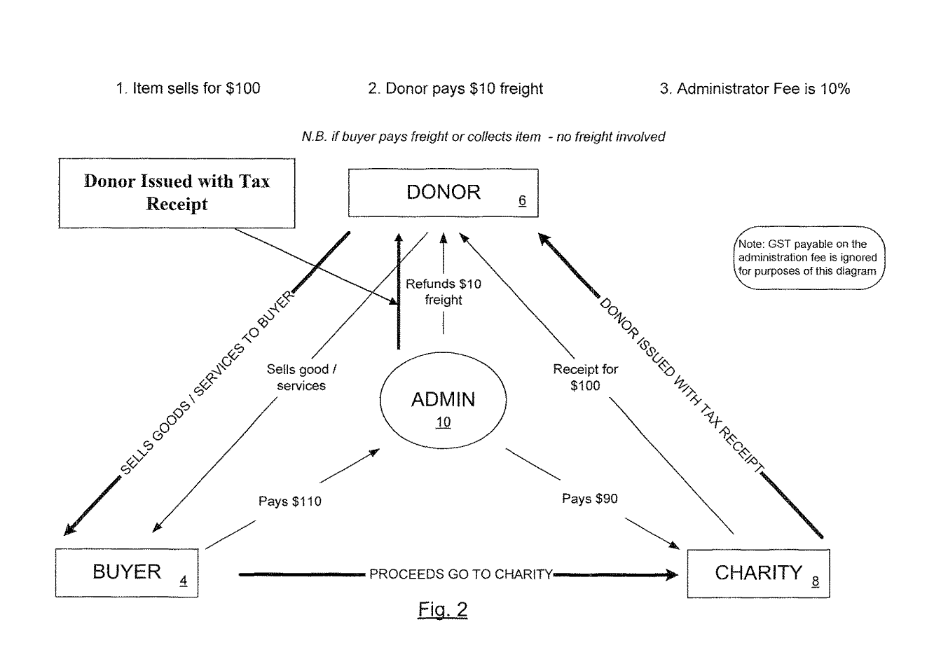

FIG. 2 shows the allocation of funds between the buyer 4, donor 6, beneficiary 8 and system administrator 10. The funds are allocated in accordance with the following relationships:

Buyer Payment=Sale Price+Freight Cost (if applicable) (1) and

Sale Price=Donation+Administrator Fee (2)

where Freight Cost and Administrator Fee can be optionally zero and if desired the sale price may equal the donation.

Considering one example, the donor 6 donates a bookshelf and the buyer 4 buys the bookshelf for a sale price of $100. The buyer 4 also pays a freight cost $10 to cover the freight cost of transporting the bookshelf from the donor 6 to the buyer 4.

Accordingly, the administrator 10 receives the buyer payment of $110 from the buyer 4 in accordance with Equation 1 above. The administrator 10 transfers the freight cost of $10 to the donor 6 who, in turn, arranges for transport of the bookshelf to the buyer 4. The administrator 10 also transfers the Sale Price less the Administrator Fee to the beneficiary 8 who, in turn, may issue a tax receipt for the $100 donation to the donor 6. Alternatively, the administrator 10 may generate a tax receipt on behalf of the beneficiary 8 and send the tax receipt to the donor 6. The administrator 10 also takes an administration fee or commission of the sale price in accordance with Equation 2 above.

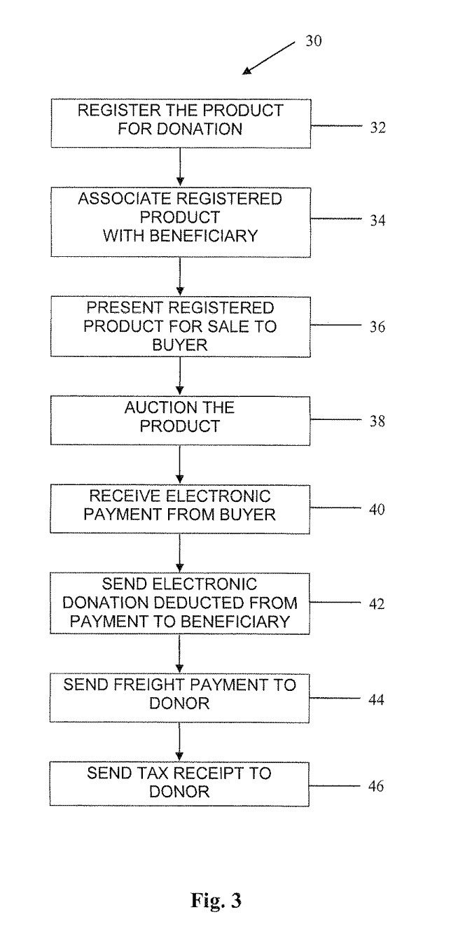

According to an embodiment of the present invention, there is provided a donation method for allocating funds as described above with reference to FIG. 2 using the donation system 2 of FIG. 1. A server of the administrator 10 (i.e. administrator server) executes at least one software product to perform the donation method 30. The software product includes machine readable instructions which are readable by the administrator server and are stored on suitable storage media, such as a magnetic or optical disk or solid state memory. The executing software product includes instructions for the administrator server to provide a website which the buyer 4 and donor 6 can access. The donation method 30 is described in detail below with reference to FIG. 3.

At step 32, the administrator server executing the software product enables the donor 6 to register the product (e.g. bookshelf) for donation on the website. Typically, the donor 6 would be presented with a series of prompts when accessing the website which enable the donor 6 to include a picture of the product, and a short description of the product in their register entry.

At step 34, the administrator server executing the software product enables the donor 6 of the product to associate the registered product with one or more beneficiary 8 to which the donation is to be provided. The or each beneficiary 8 is selected from a list of potential beneficiaries displayed on the website.

At step 36, the administrator server executing the software product presents online, the registered product for sale to the buyer 4 accessing the website. The buyer 4 may have connected to the administrator website by activating a hyperlink provided on another website associated with the beneficiary 8. In turn, the available products presented for sale on the administrator website may be corralled (or filtered) so that only those registered products associated with that particular beneficiary 8 are presented for sale to the buyer 4. That is, any products associated with other beneficiaries 8 are not presented for sale to the buyer 4 if the buyer 4 connects to the administrator website by activating the hyperlink on the beneficiary website.

At step 38, the administrator server executing the software product auctions the product on the website. The buyer 4 buys the product for the sale price by being the successful bidder in the online auction.

At step 40, the administrator server executing the software product receives electronic payment determined in accordance with Equation 1 above from the buyer 4 for the sale of the product. In this manner, the administrator server executing the software product has received the buyer card (i.e. credit card) details from the buyer 4 which were at some stage entered into the website by the buyer 4. The administrator server executing the software product sends an electronic payment request to the financial institution system 12 which, in turn, transfers the buyer payment from the buyer account 16 to the administrator account 22. If required, the buyer payment may include the freight payment as well as the sale amount of the product. The financial institution system 12 then sends to the administrator server executing the software product, an electronic confirmation of the buyer payment for the sale of the product by the buyer 4. In turn, the administrator server executing the software product can send an electronic receipt to the buyer 4 for the buyer payment.

At step 42, the administrator server executing the software product sends an electronic donation deducted from the payment to the nominated beneficiary 8 in accordance with Equation 2 above, in this manner, the administrator server executing the software product sends an electronic donation request to the financial institution system 12 for a donation deducted from the payment to be paid to the beneficiary 8. In turn, the financial institution system 12 transfers the donation from the administrator account 22 to the beneficiary account 18. The financial institution system 12 then sends to the administrator server executing the software product, an electronic confirmation that the donation has been paid to the beneficiary 8. The administrator server executing the software product can then send a donation transaction receipt electronically to the donor 6 or the beneficiary 8 via e-mail. The administrator commission remains in the administrator account 22.

At step 44, the administrator server executing the software product electronically sends any freight payment to the donor 6. In this manner, the administrator server executing the software product sends an electronic freight payment request to the financial institution system 12 for a freight payment to be paid to the donor 6. In turn, the financial institution system 12 transfers the freight payment from the administrator account 22 to the donor account 20. The financial institution system 12 then sends to the administrator server executing the software product, an electronic confirmation that the freight payment was paid to the donor 6.

Steps 36 to 44 can be performed automatically by the administrator server executing the software product without human intervention by a member of staff of the administrator 10. Alternatively, step 42 can be performed manually and periodically.

At step 46, the beneficiary 18 may generate a tax receipt for the donation. More preferably, however, the administrator generates a tax receipt on behalf of the beneficiary 8, and the tax receipt is sent electronically directly to the donor 6 for example by e-mail. This step can also be performed automatically.

Advantageously, delivery of products may be from the donor 6 directly to the buyer 4 which avoids any double handling of the products which would otherwise occur if the products were stored at an intermediate storage facility prior to actual sale (e.g. a charity shop). Furthermore, an intermediate storage facility for the product is not required at all. Another benefit of the present embodiment, is that the donor 6 is issued with a tax receipt which, if the beneficiary 8 is a charity, can be used when claiming an associated tax refund. The beneficiary may be an appeal fund like that set up to receive donations for victims of tragedies such as natural disasters or some other fund declared by authorities to be able to receive tax deductible donations.

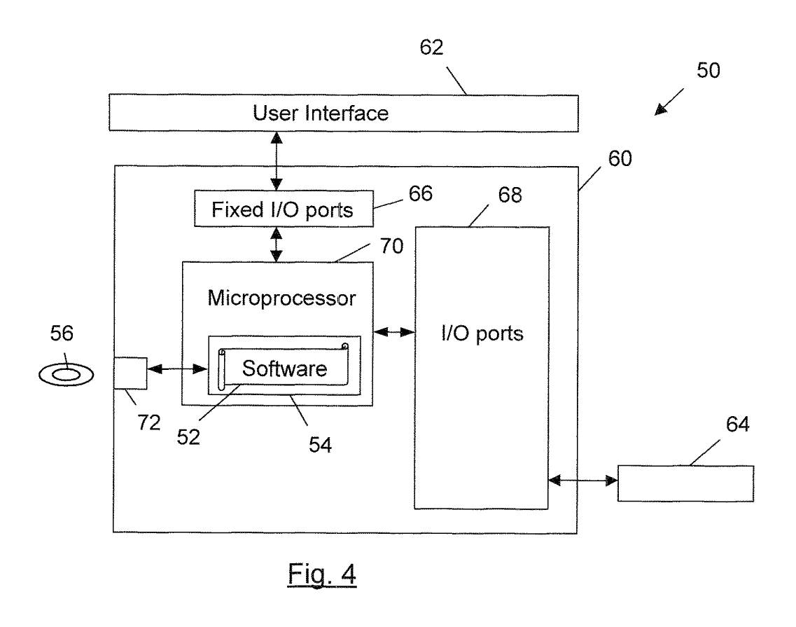

Referring to FIG. 4, the administrator server 50 executes the software product 52 stored in internal memory 54 to perform the donation method 30 previously described. The server 50 includes a computer 60 interfaced to a user interface 62, in the form of a keyboard and a display, via fixed input/output ports 66. The computer 60 is interfaced via input/output ports 68 to a broadband modem 64 which, in turn, is interfaced to the network 14.

The computer 60 includes a microprocessor 70 which interfaces to the input/output ports 66, 68. The computer 60 also includes a disk drive 72 interfaced to the microprocessor 70, in use, the software product 52 stored on a disc 56 which can loaded into the internal memory 54 using the disk drive 72.

A person skilled in the art will appreciate that many embodiments and variations can be made without departing from the ambit of the present invention.

For example, the administrator commission paid to the administrator 10 may be 0% and the donation may amount to the sale price of the product.

In one embodiment, the buyer 4 may agree to collect a bought product from the donor 6, in which case step 44 relating to the payment of a freight payment to the donor 6 need not be performed. Accordingly, the buyer payment made by the buyer 4 would also not need to include a freight cost.

In one embodiment, the donor may also associate the product with another beneficiary so that each beneficiary receives a portion of the donation.

In one embodiment, the donated product need not be auctioned. Instead, the buyer 4 may buy the registered product for a price advertised on the website.

In the preferred embodiment, the buyer 4 may make an electronic payment using a buyer card (e.g. credit card). In an alternative embodiment, the buyer can instead make an electronic payment using electronic funds transfer (EFT).

In one embodiment, the tax receipt may be sent from the beneficiary 8 to the donor 6 via the system administrator 10. In this manner, the beneficiary 8 sends the tax receipt to the administrator 10 who, in turn, forwards the tax receipt to the donor 6. Alternatively, the system administrator 10 may issue the tax receipt on behalf of the beneficiary 8 and send it directly to the donor 6.

In the embodiment described in detail above with reference to FIG. 2, the buyer 4 may make a single payment to the administrator 10 who, in turn, provided a freight payment to the donor 6 and a donation to the charity 8. In an alternative embodiment, the buyer 4 can instead make two separate payments: one payment to the administrator 10 to cover the donation and any administrator fee and another payment directly to the donor 6 to cover the freight payment. The administrator server 50 executes the software product 52 to enable the separate freight payment to be paid electronically by the buyer 4 accessing the website directly to the donor 6 and into the donor account 20.

In one embodiment, the beneficiary may include a large charity such as the Red Cross for example. In this manner, the charity could present the final stages of an online auction on a big screen at a charity event.

In compliance with the statute, the invention has been described in language more or less specific to structural or methodical features. It is to be understood that the invention is not limited to specific features shown or described since the means herein described comprises preferred forms of putting the invention into effect.

1. A method for donating to a beneficiary, the method including the steps of:
presenting online, using computational means of an administrator, a product donated by a donor and for sale to a buyer, the product being associated with the beneficiary;
enabling the administrator to receive payment from the buyer, beneficiary or an intermediary for the sale of said product; and
enabling the administrator, when the payment is received directly from the buyer or the intermediary, to send a donation deducted from the payment to the beneficiary, wherein the product is a good and/or service.

2. The method of claim 1 wherein the step of enabling the administrator to receive payment includes enabling the computational means to receive payment from the buyer, beneficiary or a financial institution system.

3. The method of claim 1 wherein the step of enabling the administrator to send the donation involves enabling the computational means to send an electronic donation deducted from the payment to the beneficiary.

4. The method of claim 1 wherein the step of enabling the administrator to send payment involves enabling the computational means to send a donation in the form of a cheque or cash deducted from the payment to the beneficiary.

5. The method of claim 3 wherein the payment of the donation is automatically performed subsequent to the receiving of the payment.

6. The method of claim 1 wherein, prior to the step of presenting, the method includes the step of filtering by beneficiary, products donated by the donor and for sale to the buyers.

7. The method of claim 1 wherein prior to the step of presenting, the method includes enabling the donor of the product to associate the product with one or more beneficiaries, and the method includes a step of sending a donation to each of the beneficiaries.

8. The method of claim 7 wherein, prior to the step of enabling the donor to associate the product with one or more beneficiaries, the method includes the step of allowing the donor to register the product for sale.

9. The method of claim 1 wherein the donation is equal to the payment.

10. The method of claim 1 wherein the donation is less than the payment and the difference between the payment and the donation includes an administration fee.

11. The method of claim 10 wherein the difference includes a freight payment, and the freight payment is forwarded to either the donor or to the buyer who directly forwards the freight payment to the donor.

12. The method of claim 1 including auctioning the product.

13. The method of claim 1 including generating a tax receipt for the donation and sending the receipt to the donor.

14. The method of claim 13 wherein the tax receipt is generated by the administrator and the administrator sends the receipt to the donor.

15. The method of claim 1 wherein the product is a good and service.

16. A method for donating to one or more beneficiaries, the method including the steps of:
presenting, with computational means of an administrator, a product donated by a donor and for sale to a buyer, the product being associated with the or each beneficiary;
receiving, with the computational means and from a financial institution system, confirmation of payment for the sale of said product by the buyer; and
sending, with the computational means and to the financial institution system, a request for a donation taken from the payment to be paid to the beneficiary.

17. The method of claim 16 wherein the method includes the steps of generating a tax receipt by the administrator for the donation, and the administrator sending the receipt to the donor.

18. A method for donating to a beneficiary, the method including the steps of:
presenting online, using computational means of an administrator, a product donated by a donor and for sale to a buyer, the product being associated with the beneficiary;
auctioning the product;
enabling the administrator to receive payment from the buyer, beneficiary or an intermediary for the sale of said product;
enabling the administrator, when the payment is received directly from the buyer or the intermediary, to send a donation deducted from the payment to the beneficiary; and
enabling the administrator, on behalf of the beneficiary, to generate a tax receipt and send the tax receipt to the donor, wherein the product is a good and/or service.

19. The method of claim 18 wherein the product is a good and service.
